(19) United States
(12) Patent Application Publication
(10) Pub. No.: US 2014/0294447 A1
(43) Pub. Date: Oct. 2, 2014

(54) IMAGE FORMING APPARATUS

(71) Applicant: SHARP KABUSHIKI KAISHA, Osaka (JP)

(72) Inventors: Yasuyuki ISHIGURO, Osaka (JP); Takeshi Okuda, Osaka (JP); Hiroshi Kubota, Osaka (JP); Eiji Tenjiku, Osaka (JP); Hisashi Kunihiro, Osaka (JP); Hitoshi Nagahama, Osaka (JP)

(73) Assignee: SHARP KABUSHIKI KAISHA, Osaka (JP)

(21) Appl. No.: 14/177,715

(22) Filed: Feb. 11, 2014

(30) Foreign Application Priority Data
Mar. 27, 2013 (JP) 2013-067603

(51) Int. Cl. G03G 15/08

(52) U.S. Cl. CPC G03G 15/0863
USPC 399/258

(57) ABSTRACT

The image forming apparatus (1) includes a toner cartridge (71) between a front frame (78) or an front inside cover (79) and a front housing, and a cartridge attaching section (65) includes a shutter stopping section (65i) for opening a shutter (71c) by attachment of the toner cartridge (71) to the toner cartridge attaching section (65), and an IC chip fitting section (65c) to which an IC chip (75) is attached.

This Nonprovisional application claims priority under 35 U.S.C. §119 on Patent Application No. 2013-067603 filed in Japan on Mar. 27, 2013, the entire contents of which are hereby incorporated by reference.

### TECHNICAL FIELD

The present invention relates to an image forming apparatus which includes a toner cartridge and forms a visible image with toner supplied from the toner cartridge.

### BACKGROUND ART

An electrophotographic image-forming device forms an electrostatic latent image in accordance with an image to be printed, and visualizes the electrostatic latent image. Specifically, the electrophotographic image-forming device includes a photoreceptor and a developing device so as to form an electrostatic latent image on the photoreceptor and to develop, namely, visualize the electrostatic latent image with toner supplied from the developing device. Note that a toner image thus formed on a surface of the photoreceptor by the development of the electrostatic latent image is transferred onto, for example, a transfer belt, and from which the image is transferred onto a sheet. Then, the electrostatic latent image is fixed on the sheet by a fixing device.

In the image forming apparatus, in a case where the toner of the developing device is consumed as a result of the development, the developing device is supplied with toner from the toner cartridge as appropriate. Further, the toner cartridge is replaced with a new toner cartridge when the toner cartridge becomes empty.

Some toner cartridges include a non-volatile memory in which information of a toner cartridge is stored. In replacement of such a toner cartridge with a new toner cartridge, the new toner cartridge is attached to the image forming apparatus in such a manner that a non-volatile memory of the new toner cartridge can communicate with the image forming apparatus.

According to a configuration of an image forming apparatus disclosed in Patent Literature 1, a toner cartridge includes a supply toner tank, a waste toner tank, a discharge-side shutter, an inflow-side shutter, a case cover, and the like. This toner cartridge is attached to a process cartridge, is located above a developing unit, and supplies the developing unit with toner stored in the supply toner tank. The waste toner tank stores waste toner collected by a photoreceptor cleaning unit. The toner cartridge is replaced with a new toner cartridge when the toner stored in the supply toner tank is finished or when the waste toner stored in the waste toner tank becomes excessive in amount.

According to a configuration of an image forming apparatus disclosed in Patent Literature 2, a rotary developing unit includes developing cartridges each provided with a memory IC connector. In replacement of the developing cartridge with a new one, a device-side connector is moved forward by being driven by a driving section including a motor, so that the device-side connector is electrically connected to the memory IC connector.

According to a configuration of an image forming apparatus disclosed in Patent Literature 3, toner cartridges are arranged near a front surface of the image forming apparatus and in parallel to a rotation direction of an intermediate transfer member, and a toner cartridge cover is openably provided so as to cover all the toner cartridges. Further, an image reading section is disposed above the image forming apparatus in such a manner that the image reading section does not cover the toner cartridges. With this, the toner cartridge, which is frequently replaced, can be attached or detached without taking away the image reading section. Further, even in a case where a single function printer (SFP) is modified into a multifunction printer (MFP), it is possible to handle the toner cartridges in the same manner also in the MFP. Thus, the MFP can keep substantially the same operability regarding attachment/detachment of the toner cartridges as that of SFP.

### CITATION LIST

### Patent Literatures

Patent Literature 1

Japanese Patent Application Publication, Tokukai, No. 2008-233548 A (Publication Date: Oct. 2, 2008)

Patent Literature 2

Japanese Patent Application Publication, Tokukai, No. 2003-257522 A (Publication Date: Sep. 12, 2003)

Patent Literature 3

Japanese Patent Application Publication, Tokukai, No. 2009-181023 A (Publication Date: Aug. 13, 2009)

### SUMMARY OF INVENTION

### Technical Problem

For an image forming apparatus including the toner cartridge including the non-volatile memory, there has been the following demand in attachment of the toner cartridge to the image forming apparatus (e.g., in replacement of the toner cartridge with a new toner cartridge). Specifically, the demand is to make it possible (i) to easily attach the toner cartridge to the image forming apparatus so that toner can be supplied from the toner cartridge and (ii) to attach the non-volatile memory to the image forming apparatus in such a manner that the non-volatile memory can communicate with the image forming apparatus, as a result of the attachment of the toner cartridge to the image forming apparatus.

Regarding this demand, the image forming apparatus disclosed in Patent Literature 1 does not consider the configuration of the toner cartridge including the nonvolatile memory and the configuration for facilitating attachment of the toner cartridge and the non-volatile memory.

The configuration of the image forming apparatus disclosed in Patent Literature 2 becomes extensive, because a connection between the memory IC connector provided in the developing cartridge and the device-side connector is carried out by the driving section including the motor. Further, the memory IC connector and the device-side connector usually stay apart from each other. Therefore, when communication between the memory IC connector and the device-side connector is required, they cannot start communication immediately.

According to the configuration of the image forming apparatus disclosed in Patent Literature 3, it is possible to secure the operability regarding attaching/detaching of the toner cartridge. However, the image forming apparatus disclosed in Patent Literature 3 does not consider the configuration of the toner cartridge including the non-volatile memory and the configuration for attaching the non-volatile memory in the toner cartridge to the image forming apparatus in such a manner that the non-volatile memory can communicate with the image forming apparatus.

Therefore, an object of the present invention is to provide an image forming apparatus which makes it possible (i) to easily attach a toner cartridge to an image forming apparatus so that toner can be supplied from the toner cartridge and (ii) to, with a simple configuration, attach a non-volatile memory in the toner cartridge to the image forming apparatus in such a manner that the non-volatile memory can communicate with the image forming apparatus, as a result of the attachment of the toner cartridge to the image forming apparatus.

### Solution to Problem

In order to attain the foregoing object of the present invention, an image forming apparatus of an aspect of the present invention includes: a front housing section; a front frame provided inside the image forming apparatus so as to be close to a front surface of the image forming apparatus; a front inside cover provided between the front housing section and the front frame; and a cartridge attaching section, provided between the front housing section and the front frame or the front inside cover, to which a toner cartridge including a non-volatile memory is detachably attachable, the toner cartridge including a shutter for opening or closing a toner supply opening of the toner cartridge, the cartridge attaching section including: a shutter opening section which engages with the shutter as a result of movement of the toner cartridge toward the cartridge attaching section, so as to open the shutter; and a non-volatile memory attaching section to which the non-volatile memory is attached when the toner cartridge is attached to the cartridge attaching section.

### ADVANTAGEOUS EFFECTS OF INVENTION

According to the aspect of the present invention, it is possible (i) to easily attach a toner cartridge to an image forming apparatus so that toner can be supplied from the toner cartridge and (ii) to, with a simple configuration, attach a non-volatile memory in the toner cartridge to the image forming apparatus in such a manner that the non-volatile memory can communicate with the image forming apparatus, as a result of the attachment of the toner cartridge to the image forming apparatus.

### BRIEF DESCRIPTION OF DRAWINGS

FIG. 1 is a perspective view of an image forming apparatus of an embodiment of the present invention.

FIG. 2 is a perspective view of the image forming apparatus with a front door shown in FIG. 1 being opened.

FIG. 3 is an elevational view of the image forming apparatus with the front door shown in FIG. 1 being opened.

FIG. 4 is a perspective view of developing devices included in the image forming apparatus shown in FIG. 1.

FIG. 5 is an elevational view illustrating an inner configuration of the image forming apparatus shown in FIG. 1.

FIG. 6 is a perspective view of a toner cartridge shown in FIG. 3.

FIG. 7 is a plan view of the toner cartridge shown in FIG. 6.

(a) of FIG. 8 shows a side view of the toner cartridge and a longitudinal section view of a shutter of the toner cartridge shown in FIG. 6 being closed. (b) of FIG. 8 shows a side view of the toner cartridge and a longitudinal section view of the shutter shown in (a) of FIG. 8 being opened. (c) of FIG. 8 is a plan view illustrating a spring connecting section of a toner storing section shown in (a) of FIG. 8. (d) of FIG. 8 is an elevational view illustrating another spring connecting section of the shutter shown in (a) of FIG. 8.

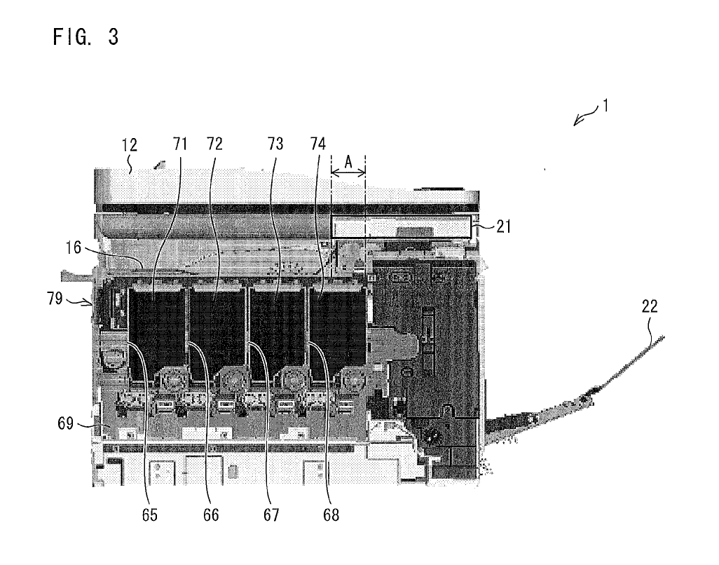

(a) of FIG. 9 is a longitudinal section view of a back wall of the toner cartridge shown in FIG. 3. (b) of FIG. 9 is a view showing how to handle the toner cartridge with use of a recess on the back wall.

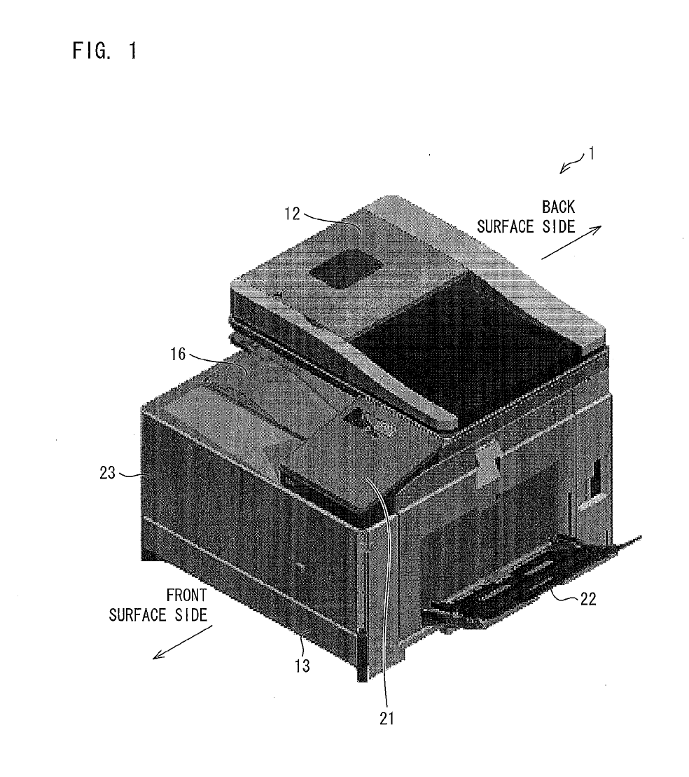

FIG. 10 is an elevational view schematically illustrating a configuration of a cartridge attaching section of the image forming apparatus shown in FIG. 1 and a part around the cartridge attaching section.

(a) of FIG. 11 is an elevational view of the cartridge attaching section shown in FIG. 10. (b) of FIG. 11 is a view illustrating the toner cartridge and the developing device shown in (a) of FIG. 11.

FIG. 12 shows longitudinal cross section views respectively illustrating (i) a state in which the toner cartridge is not attached to the cartridge attaching section and (ii) a state in which the toner cartridge is attached to the cartridge attaching section shown in FIG. 11.

FIG. 13 is an elevational view showing a relative position of the toner cartridge, a waste toner box, an operation panel, and a fixing section of the image forming apparatus shown in FIG. 1.

(a) of FIG. 14 is a perspective view illustrating a position of the operation panel relative to an outer surface of the front door of the image forming apparatus shown in FIG. 1. (b) of FIG. 14 is a perspective view illustrating how the operation panel is positioned relative to the outer surface of the front door.

### DESCRIPTION OF EMBODIMENTS

(Overall Configuration of Image Forming Device)

The following will describe an embodiment of the present invention with reference to the drawings. FIG. 1 is a perspective view illustrating an image forming apparatus 1 of the embodiment of the present invention. The image forming apparatus 1 is a full color printer in the present embodiment. Therefore, the image forming apparatus 1 is configured to print a color image on a sheet (a recording medium in the form of sheet) in accordance with image data externally supplied. Note here that the present embodiment describes an example where the image forming apparatus 1 is a printer. Alternatively, the image forming apparatus may be a copy machine, a fax machine, or a multifunction peripheral having functions of these machines. In this case, the image forming apparatus 1 prints on a sheet a multicolor image or a single color image in accordance with image data externally supplied and/or image data which is read from a document by a scanner. Note that the image forming apparatus 1 may be a monochrome printer.

The image forming apparatus 1 includes an automatic document feeder 12 in a region of a top surface of the image forming apparatus 1, the region being close to a back surface of the image forming apparatus 1 (see FIG. 1). The image forming apparatus 1 includes a housing and a paper output tray 16 which is provided in a region of an upper surface of the housing, the region being closer to a front surface of the image forming apparatus 1 than the automatic document feeder 12 is. The image forming apparatus 1 includes an operation panel 21 on the right side (when facing the front surface of the image forming apparatus 1) of the paper output tray 16. The operation panel 21 includes a display device. Further, the image forming apparatus 1 includes a paper feeding cassette 13 which is provided at a bottom of the image forming apparatus 1 and which can be pulled forward, and a foldable manual paper feeding tray 22 which is provided on the right side (when facing the front surface of the image forming apparatus 1) of the image forming apparatus 1. Moreover, the image forming apparatus 1 includes a front door (front housing section) 23 on the front surface and above the paper feeding cassette 13. The front door 23 can be vertically opened and closed around its lower end which serves as a rotational axis.

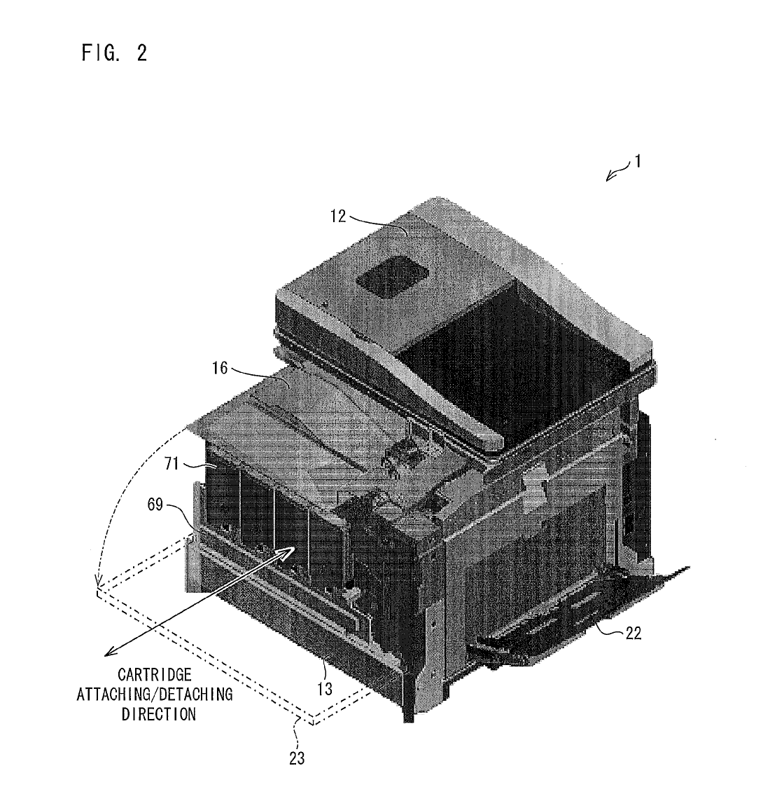

The image forming apparatus 1 includes, in its inner part that is exposed when the front door 23 is opened, toner cartridges 71 to 74 and a waste toner box 69 so that the toner cartridges 71 to 74 are positioned above the waste toner box 69 (see FIGS. 2 and 3). FIG. 2 is a perspective view of the image forming apparatus with the front door 23 shown in FIG. 1 being opened. FIG. 3 is an elevational view of the image forming apparatus 1 with the front door 23 shown in FIG. 1 being opened.

The toner cartridges 71 to 74 are disposed so as to be close to the front surface and are aligned at the same height in a lateral direction of the image forming apparatus 1 (see FIGS. 2 and 3). These toner cartridges 71 to 74 are respectively attached to cartridge attaching sections 65 to 68 formed on a front inside cover 79 of the image forming apparatus 1, which front inside cover 79 is made from, for example, an ABS resin. In the present embodiment, the toner cartridges 71 to 74 store yellow toner, magenta toner, cyan toner, and black toner, respectively.

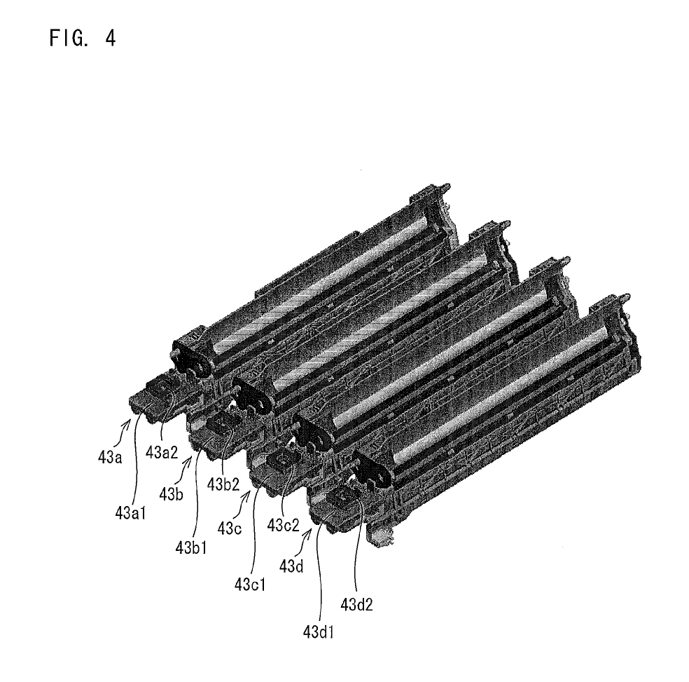

Inside the image forming apparatus 1, there are provided four developing devices 43a to 43d respectively corresponding to positions of the four toner cartridges 71 to 74. FIG. 4 is a perspective view of the developing devices 43a to 43d. The developing devices 43a to 43d respectively include (i) toner intake sections 43a1 to 43d1 extending forward and (ii) toner intake openings 43a2 to 43d2 being provided on upper sides of the toner intake sections 43a1 to 43d1 (see FIG. 4). These developing devices 43a to 43d are located under their corresponding toner cartridges 71 to 74, and receive the toner supplied from the toner cartridges 71 to 74, respectively.

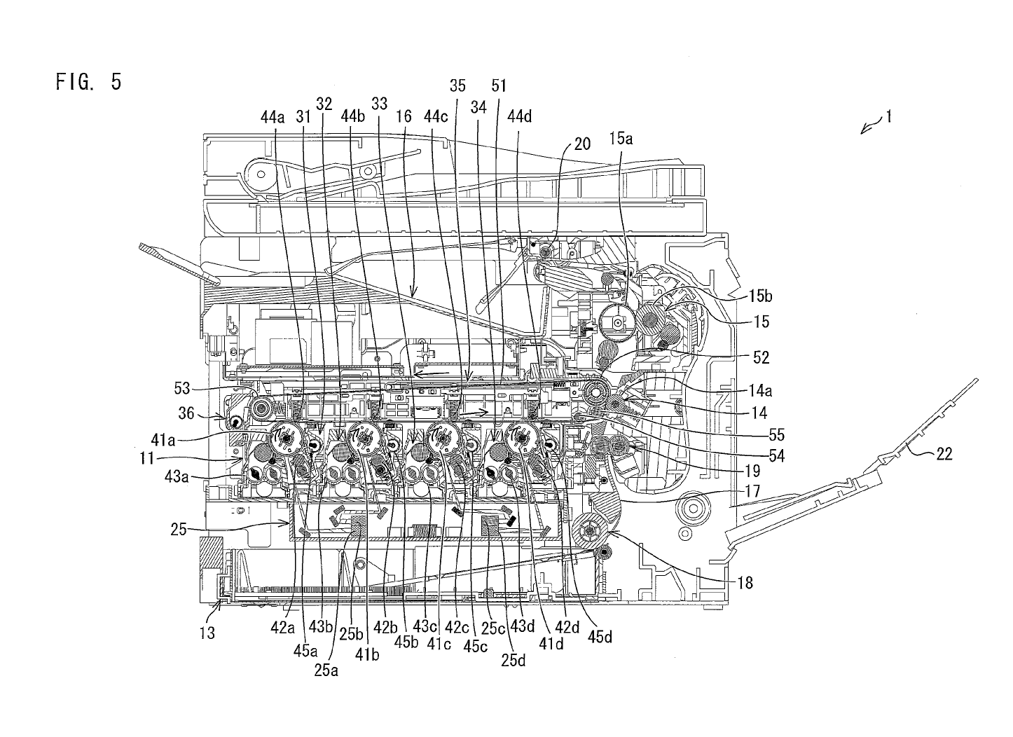

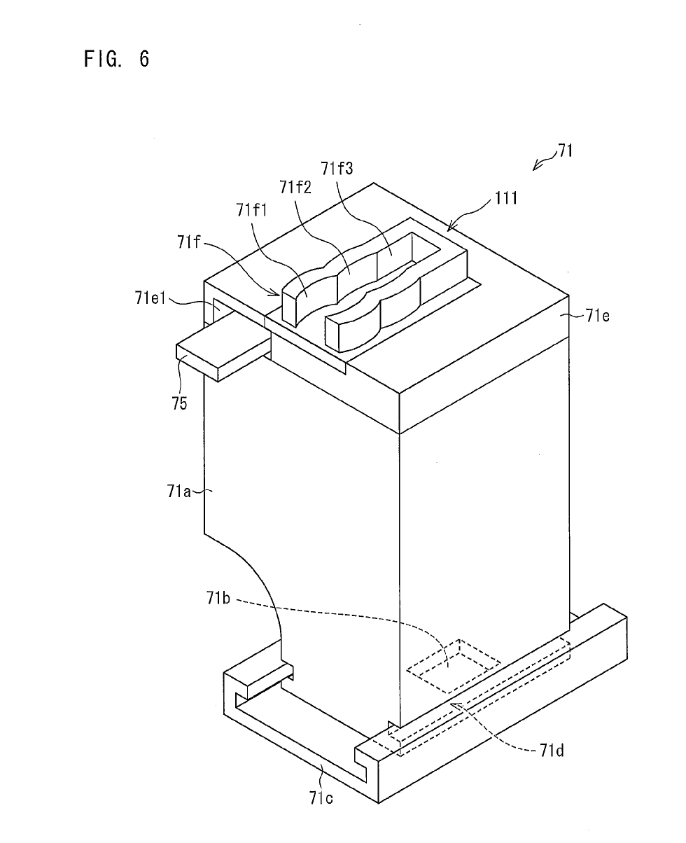

FIG. 5 is an elevational view illustrating an inner configuration of the image forming apparatus 1. The image forming apparatus 1 includes a process unit 11 provided on a lower side thereof (see FIG. 5). Below the process unit 11, there are provided a laser optical unit 25 and the paper feeding cassette 13 disposed in this order from the top. Further, there is provided a transfer section 14 on the right side (when seen in FIG. 5) of the process unit 11, and there is provided a fixing section 15 above the transfer section 14.

A pathway from the paper feeding cassette 13 to the paper output tray 16 includes a paper carrying path 17. The paper carrying path 17 is provided with a paper feeding roller 18, a timing roller 19, the transfer section 14, the fixing section 15, and a paper ejection roller 20 disposed in this order along a direction from the paper feeding cassette 13 to the paper output tray 16.

The process unit 11 includes first to fourth image forming sections 31 to 34, an intermediate transfer belt unit 35, and a transfer belt cleaning device 36. The first to fourth image forming sections 31 to 34 are provided for yellow toner, magenta toner, cyan toner, and black toner, respectively.

The first image forming section 31 includes a photoreceptor drum 41a, a charger 42a, the developing device 43a, an intermediate transfer roller 44a, and a photoreceptor cleaning unit 45a.

The charger 42a charges a surface of the photoreceptor drum 41a to a predetermined electric potential. The developing device 43a develops, with toner, an electrostatic latent image formed on the surface of the photoreceptor drum 41a as a result of exposure of the photoreceptor drum 41a to a laser beam emitted from the laser optical unit 25. The intermediate transfer roller 44a is provided on a back surface of an intermediate transfer belt 51 in the intermediate transfer belt unit 35, and transfers a toner image thus formed on the surface of the photoreceptor drum 41a by the development to a surface of the intermediate transfer belt 51. A photoreceptor cleaning device 45a removes and collects remaining toner and paper powder on the surface of the photoreceptor drum 41a after the development and the image transfer.

Similarly, the second image forming section 32 includes a photoreceptor drum 41b, a charger 42b, a developing device 43b, an intermediate transfer roller 44b, and a photoreceptor cleaning device 45b. The third image forming section 33 includes a photoreceptor drum 41c, a charger 42c, a developing device 43c, an intermediate transfer roller 44c, and a photoreceptor cleaning device 45c. The fourth image forming section 34 includes a photoreceptor drum 41d, a charger 42d, a developing device 43d, an intermediate transfer roller 44d, and a photoreceptor cleaning device 45d.

The intermediate transfer belt unit 35 includes the intermediate transfer belt 51, a driving roller 52 for supporting the intermediate transfer belt 51, a driven roller 53, and tension rollers 54 and 55. The transfer belt cleaning device 36 removes remaining toner and paper powder on the surface of the intermediate transfer belt 51.

The laser optical unit 25 includes laser sources 25a to 25d provided respectively for the photoreceptor drums 41a to 41d, and irradiates the photoreceptor drums 41a to 41d with laser beams emitted from the laser sources 25a to 25d so that an electrostatic latent image corresponding to an image to be printed by an image forming apparatus 2 is formed on surfaces of the photoreceptor drums 41a to 41d.

The transfer section 14 includes a transfer roller 14a which is pressed onto the driving roller 52 of the intermediate transfer belt unit 35 via the intermediate transfer belt 51, and transfers the toner image formed on the surface of the intermediate transfer belt 51 to a sheet fed from the paper feeding cassette 13. The fixing section 15 includes a fixing roller 15a and a pressure roller 15b by which the toner image on the sheet is melted so as to be fixed onto the sheet.

(Image Forming Operation)

The image forming apparatus 1 configured as described above prints a color image in the following manner. According to inputted image data, the laser optical unit 25 emits a laser beam onto the photoreceptor drums 41a to 41d, so that electrostatic latent images are formed on the photoreceptor drums 41a to 41d. The electrostatic latent images are developed with toner supplied from the developing devices 43a to 43d. Then, toner images colored in yellow, magenta, cyan, and black are formed on surfaces of the photoreceptor drums 41a to 41d, respectively.

These toner images are successively transferred onto the same position on the intermediate transfer belt 51 of the intermediate transfer belt unit 35 so as to overlap with each other, and a resulting image is further transferred onto a sheet by the transfer section 14. The sheet is fed from the paper feeding cassette 13 to the paper carrying path 17 by the paper feeding roller 18, and then is fed to the transfer section 14 by the timing roller 19 at a timing when the toner image on the intermediate transfer belt 51 is supplied to the transfer section 14.

The sheet onto which the toner image is transferred by the transfer section 14 is conveyed to the fixing section 15, so that the toner image is fixed onto the sheet by the fixing section 15. Then, the sheet is discharged onto the paper output tray 16 by the paper ejection roller 20.

(Toner Cartridge)

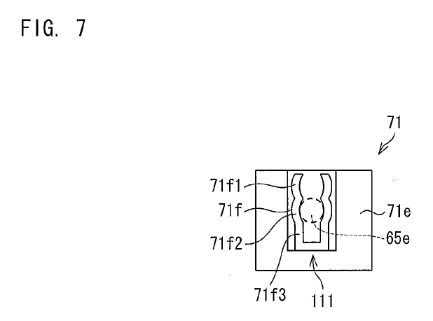

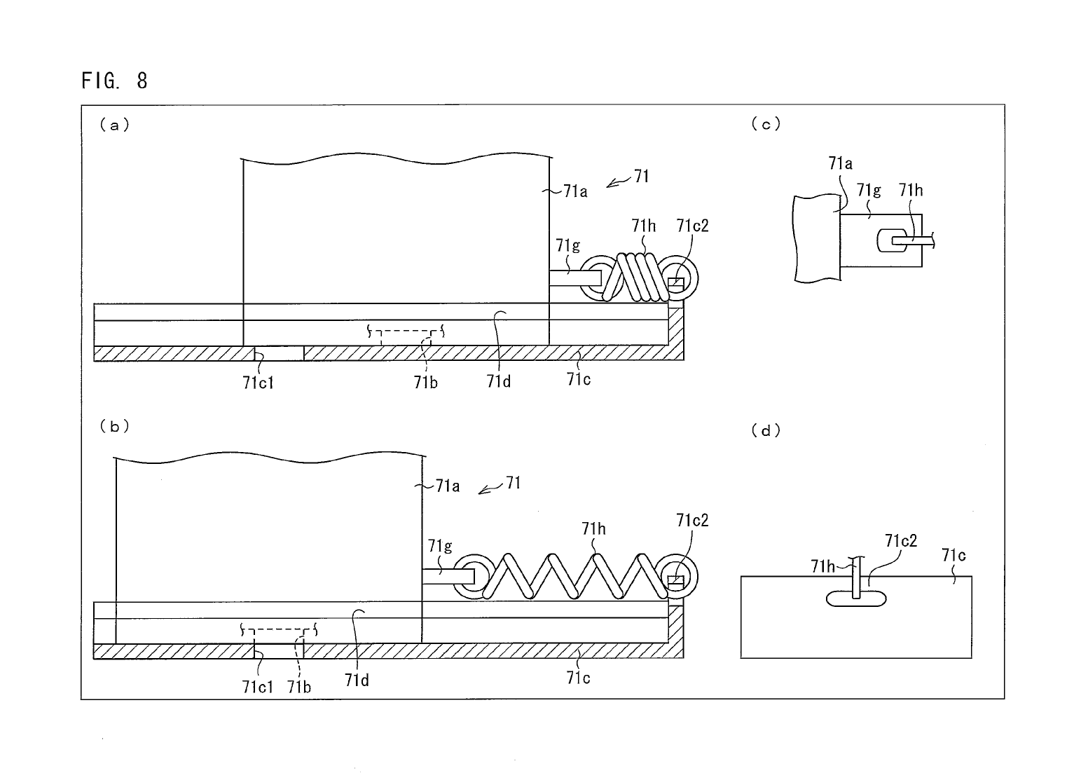

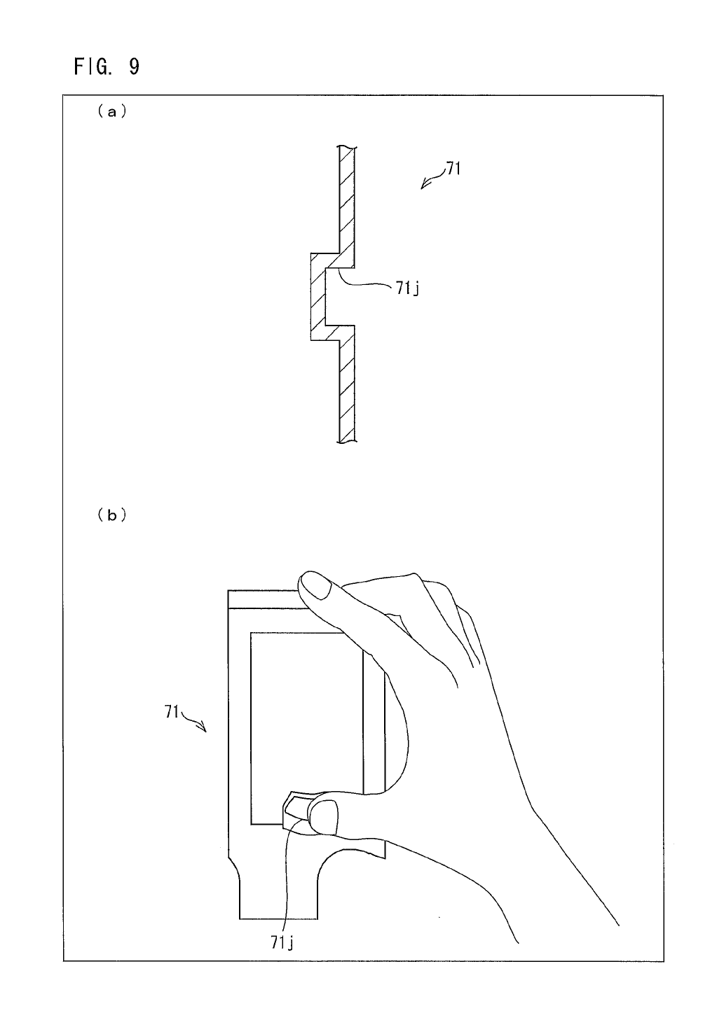

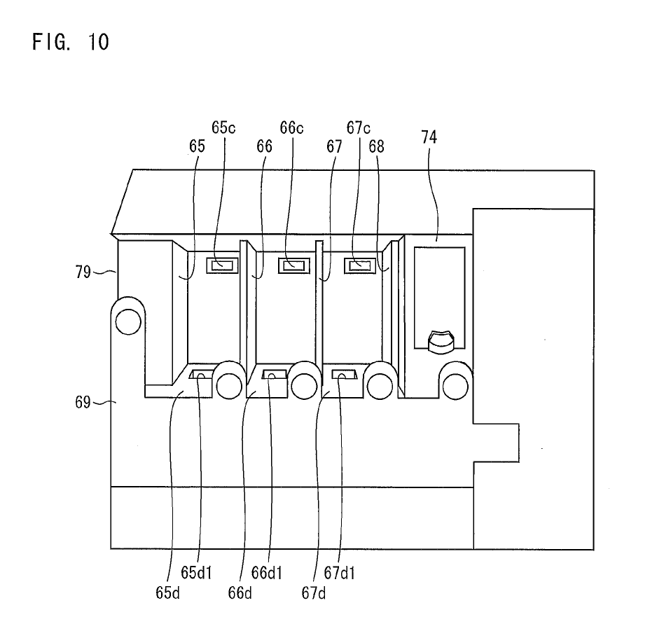

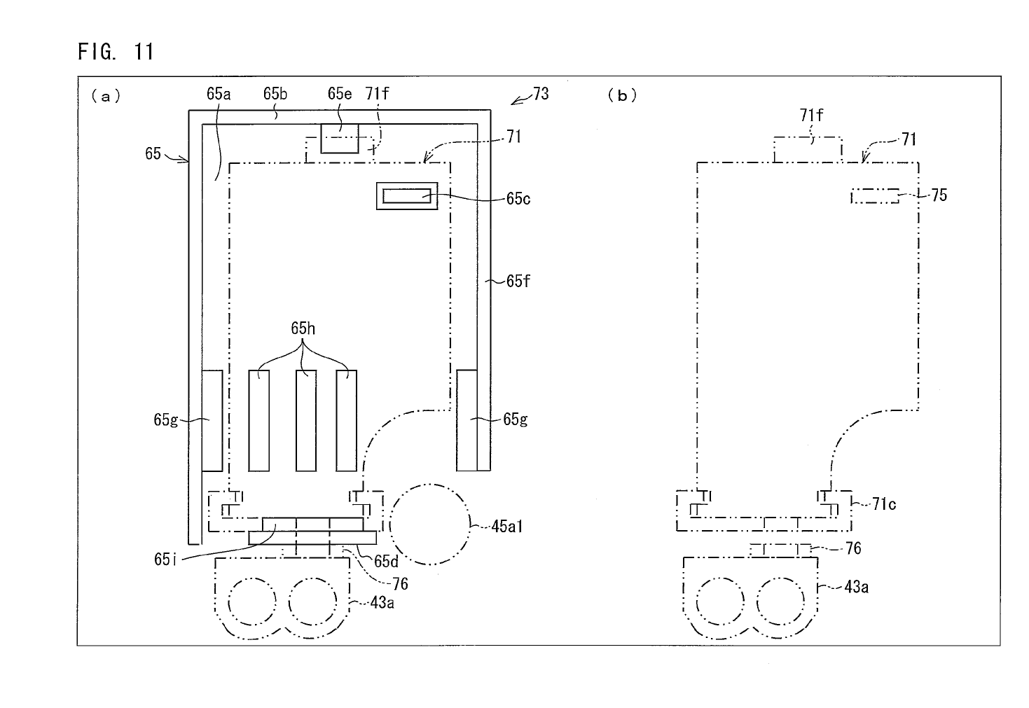

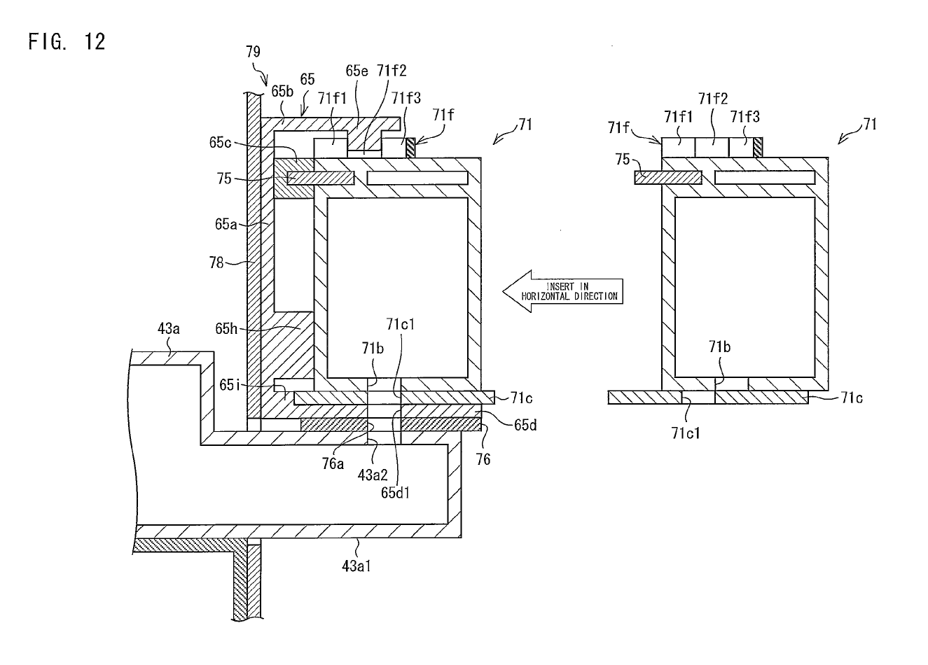

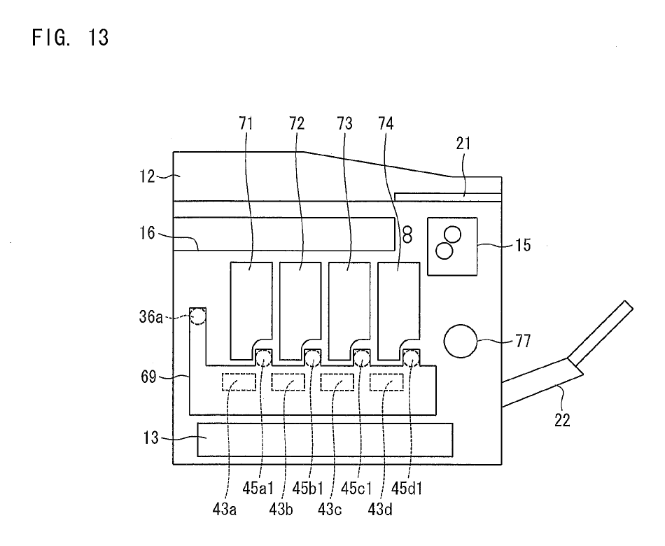

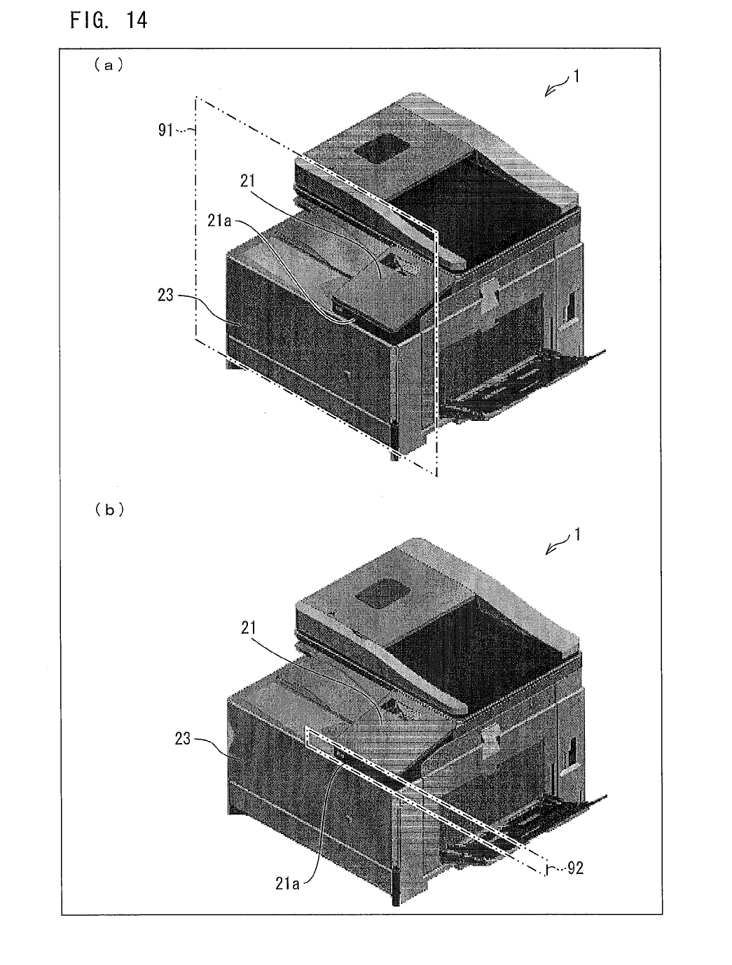

FIG. 6 is a perspective view of a toner cartridge 71. FIG. 7 is a plan view of the toner cartridge 71. Since the toner cartridges 71 to 74 have the same configuration and the cartridge attaching sections 65 to 68 have the same configuration, the toner cartridge 71 and the cartridge attaching section 65 will be explained as an example.

The toner cartridge 71 has a vertically long shape, and includes a toner storing section 71a for storing toner therein (see FIG. 6). The toner storing section 71a has a toner supply opening 71b located in a lower end of the toner storing section 71a. Further, the toner storing section 71a includes a shutter 71c for opening and closing the toner supply opening 71b. The toner storing section 71a has lateral sides facing each other, each of the lateral sides being provided with a shutter holding groove 71d which holds the shutter 71c and by which sliding of the shutter 71c is guided.

On the toner storing section 71a, a memory covering member 71e is provided. The memory covering member 71e has a surface facing the image forming device 1 and having a memory holding recess 71e1. The memory holding recess 71e1 holds an IC chip 75 including a non-volatile memory (CRUM).

The IC chip 75 stores, for example, main body information, history information, and recycle information which are related to the toner cartridges 71 to 74. The main body information is indicative of, e.g., a product number (proper information), a content, a color of toner stored, a lot number, a production date, a manufacturer, and an address and telephone number of the manufacturer, each relating to each of the toner cartridges 71 to 74. The history information is indicative of, e.g., a remaining amount of toner, a starting date of use, and hour(s) of actual use. The recycle information is indicative of, e.g., the number of times being recycled, a date of recycle, a collector, and an address and telephone number of the collector. The information stored in the IC chip 75 is read out by a control section (not illustrated) of the image forming apparatus 1, and is appropriately displayed on the display device included in the operation panel 21.

(a) of FIG. 8 shows a side view of the toner cartridge 71 and a longitudinal section view of the shutter 71c which is closed. (b) of FIG. 8 shows a side view of the toner cartridge 71 and a longitudinal section view of the shutter 71c which is opened. (c) of FIG. 8 is a plan view illustrating a spring connecting section 71g of the toner storing section 71a. (d) of FIG. 8 is an elevational view illustrating a spring connecting section 71c2 of the shutter 71c.

The toner cartridge 71 has a surface on which the spring connecting section 71g is provided, the surface being opposite to the surface facing the image forming apparatus 1 (see FIG. 8). Correspondingly, the shutter 71c has an edge on which the spring connecting section 71c2 is provided, the edge (hereinafter, referred to as a “rear edge”) facing the spring connecting section 71g. The spring connecting sections 71g and 71c2 are respectively connected with ends of a tension spring 71h which is made of a coil spring. Further, the shutter 71c has a portion facing the bottom of the toner storing section 71a and having a toner passing opening 71c1 (see (a) of FIG. 8).

In a state where the toner cartridge 71 is not attached to the cartridge attaching section 65, the shutter 71c is closed so that the toner supply opening 71b is covered (see (a) of FIG. 8). In contrast, in a state where the toner cartridge 71 is attached to the cartridge attaching section 65, the shutter 71c is opened so that the toner supply opening 71b and the toner passing opening 71c1 make a passage (see (b) of FIG. 8).

An upper surface of the toner cartridge 71, namely, an upper surface of the memory covering member 71e is provided with a fitted section 71f which protrudes upward (see FIGS. 6 and 7). The fitted section 71f and a fitting protrusion 65e of the cartridge attaching device 65 constitute a fixing mechanism 111.

The fitted section 71f has a fitting guiding section 71f1, a fitting holding section 71f2, and a U-shaped section 71f3, which are arranged in this order from (i) a first surface of the fitted section 71f facing the image forming apparatus 1 when the toner cartridge 71 is attached to the image forming apparatus 1 to (ii) a second surface of the fitted section 71f being opposite to the first surface.

The fitting guiding section 71f1 is constituted by two arc-shaped walls facing each other at a given space. The fitting holding section 71f2 is constituted by two arc-shaped walls which are connected to the arc-shaped walls of the fitting guiding section 71f1 and face each other at a space narrower than that of the fitting guiding section 71f1. The U-shaped section 71f3 is constituted by a U-shaped wall which is connected to the arc-shaped walls of the fitting holding section 71f2.

Therefore, in each of (i) a part where the fitting guiding section 71f1 and the fitting holding section 71f2 are connected to each other and (ii) a part where the fitting holding section 71f2 and the U-shaped section 71f3 are connected to each other, a space between the walls facing each other is narrower. Consequently, the fitted section 71f has constrictions at these parts. With this, when the toner cartridge 71 moves toward the image forming apparatus 1 so as to be attached thereto, the fitting protrusion 65e, which is to be fitted to the fitted section 71f (see FIG. 12), passes through the fitting guiding section 71f1 and then reaches the fitting holding section 71f2, so as to be accommodated and held by the fitting holding section 71f2.

Each of the walls constituting the fitting guiding section 71f1, the fitting holding section 71f2, and the U-shape section 71f3 has a thickness in a range of 1.0 mm to 2.0 mm, as well as that of a surrounding wall of the toner storing section 71a. The fitted section 71f is molded concurrently with the toner storing section 71a in a process for molding the toner cartridge 71 with a resin.

(a) of FIG. 9 is a longitudinal section view of a back wall of the toner cartridge 71 (a wall of the toner cartridge 71 being opposite to a wall of the toner cartridge 71 facing the cartridge attaching section 65). (b) of FIG. 9 is a view showing how to handle the toner cartridge 71 with use of a recess on the back wall.

The toner cartridge 71 has a recess 71j in a lower part of a back surface of the toner cartridge 71 (a surface of the toner cartridge 71 being opposite to a surface of the toner cartridge 71 facing the cartridge attaching section 65) (see (a) of FIG. 9). The recess 71j has a size enough to allow a thumb of a person to be inserted thereinto.

Therefore, an operator can detach the toner cartridge 71 from the cartridge attaching section 65 by holding the toner cartridge 71 with his/her thumb inserted into the recess 71j and other fingers placed on the upper surface of the toner cartridge 71 (see (b) of FIG. 9).

(Cartridge Attaching Section)

FIG. 10 is an elevational view schematically illustrating a configuration of the cartridge attaching sections 65 to 68 of the image forming apparatus 1 and a part around the cartridge attaching sections 65 to 68. (a) of FIG. 11 is an elevational view of the cartridge attaching section 65. (b) of FIG. 11 is a view illustrating the toner cartridge 71 and the developing device 43a shown in (a) of FIG. 11. FIG. 12 shows longitudinal cross section views respectively illustrating (i) a state in which the toner cartridge 71 is not attached to the cartridge attaching section 65 and (ii) a state in which the toner cartridge 71 is attached to the cartridge attaching section 65. Note that FIG. 10 shows a state in which only the toner cartridge 74 is attached to the cartridge attaching section 68.

The cartridge attaching sections 65 to 68 are formed on a front surface of the front inside cover 79, and are separated from each other for their respective toner cartridges 71 to 74 (see FIG. 10). The front inside cover 79 is attached to, for example, a front frame 78 made from iron which is located on the front surface side of the image forming apparatus 1 (see FIG. 12).

The following description deals with the cartridge attaching section 65 and the toner cartridge 71 as an example. The cartridge attaching section 65 includes a cartridge facing section 65a facing the toner cartridge 71 and an upper wall part 65b which extends from a top edge of the cartridge facing section 65a orthogonally to the cartridge facing section 65a so as to cover the toner cartridge 71. The upper wall part 65b has a lower surface provided with the fitting protrusion 65e protruding downward.

The cartridge facing section 65a is provided with an IC chip fitting section (non-volatile memory attaching section) 65c being a recess to which the IC chip 75 is fitted when the toner cartridge 71 is attached to the cartridge attaching section 65. Note that FIG. 10 also shows IC chip fitting sections 66c and 67c respectively provided for cartridge attaching sections 66 and 67.

The cartridge section 65 includes, in its lower part, a lower cartridge guiding section 65d for guiding the toner cartridge 71 when the toner cartridge 71 is attached to the cartridge attaching section 65. Note that FIG. 10 also shows lower cartridge guiding sections 66d and 67d for their respective cartridge attaching sections 66 and 67.

The lower cartridge guiding section 65d has a toner passing opening 65d1 which allows passage of toner supplied via the toner supply opening 71d and the toner passing opening 71c1 of the toner cartridge 71. Note that FIG. 10 also shows lower cartridge guiding sections 66d1 and 67d1 for their respective cartridge attaching sections 66 and 67.

The cartridge attaching section 65 includes side walls 65f facing each other. On inner surfaces of side walls 65f, side cartridge guiding sections 65g are formed.

Further, the cartridge facing section 65a includes cartridge contacting sections 65h and a shutter stopping section 65i provided under the cartridge contacting sections 65h.

Around the toner intake opening 43a2 made on the toner intake section 43a1 of the developing device 43a, there is provided a toner leak-proof member 76 having a toner passing opening 76a and being made of, e.g., a sponge.

(Waste Toner Box)

FIG. 13 is an elevational view showing a relative position of the toner cartridges 71 to 74, the waste toner box 69, the operation panel 21, and the fixing section 15 in the image forming apparatus 1.

The waste toner box 69 is shaped in, for example, a thin rectangular box, and stores waste toner and paper powder collected by the transfer belt cleaning device 36 and the photoreceptor cleaning devices 45a to 45d. Because of this, the waste toner box 69 is connected with (i) a waste toner conveying pipe 36a connected to the transfer belt cleaning device 36 and (ii) waste toner conveying pipes 45a1 to 45d1 respectively connected to the photoreceptor cleaning devices 45a to 45d. Once the waste toner box 69 is filled with waste toner, the waste toner box 69 is replaced with an empty waste toner box. Note that the waste toner and/or the like is conveyed from the transfer belt cleaning device 36 and the photoreceptor cleaning devices 45a to 45d to the waste toner box 69 by, for example, waste toner conveying screws included in the transfer belt cleaning device 36 and the photoreceptor cleaning devices 45a to 45d.

(Position of Operation Panel)

(a) of FIG. 14 is a perspective view illustrating a position of the operation panel 21 relative to an outer surface of the front door 23 of the image forming apparatus 1. (b) of FIG. 14 is a perspective view illustrating how the operation panel 21 is positioned relative to the outer surface of the front door 23.

The operation panel (display device) 21 is provided on the upper surface of the housing of the image forming apparatus 1 and is located partly (part A) immediately above a region where the toner cartridge 74 exists (see FIG. 3).

The operation panel 21 includes a front end surface 21a which is located so as to be closer to the back surface of the image forming apparatus 1 than the outer surface of the front door 23 is (see (a) of FIG. 14). Note that a surface 91 indicates a surface including the outer surface of the front door 23. The front end surface 21a of the operation panel 21 is parallel to the outer surface of the front door 23 (see (b) of FIG. 14). Note also that a surface 92 indicates a surface including the front end surface 21a of the operation panel 21. In the case where the image forming apparatus 1 is positioned so as to be in a horizontal state, the front door 23 is substantially vertical to a horizontal surface.

The following description deals with an example where the toner cartridge 71 is replaced with a new one in the configuration described above.

(Attachment of Toner Cartridge to Cartridge Attaching Section)

In order to attach the toner cartridge 71 to the cartridge attaching section 65, the front door 23 is opened, and then the toner cartridge 71 is pushed into the image forming apparatus 1 toward the cartridge attaching section 65. That is, the toner cartridge 71 is horizontally moved from the front surface to the back surface of the image forming apparatus 1.

During this, the toner cartridge 71 can be stably moved by being guided by the lower cartridge guiding section 65d and side cartridge guiding sections 65g of the cartridge attaching section 65.

Pushing the toner cartridge 71 toward the cartridge attaching section 65 causes a tip of the shutter 71c to come in contact with the shutter stopping section 65i (see FIG. 12). This does not allow the shutter 71c to move any more, thereby causing only the toner storing section 71a to move toward the cartridge attaching section 65.

Thereafter, a front surface of the toner storing section 71a comes in contact with the cartridge contacting sections 65h, so that the toner cartridge 71 is completely attached to the cartridge attaching section 65. In this state, the toner supply opening 71b of the toner storing section 71a, the toner passing opening 71c1 of the shutter 71c, the toner passing opening 65d1 of the lower cartridge guiding section 65d, the toner passing opening 76a of the toner leak-proof member 76, and the toner intake opening 43a2 on the toner intake section 43a1 of the developing device 43a are matched each other to make a passage (see FIG. 12). This allows supply of toner from the toner cartridge 71 to the developing device 43a.

In the case where the toner cartridge 71 is completely attached to the cartridge attaching section 65 as above, the fitting protrusion 65e of the cartridge attaching section 65 is fitted to the fitting holding section 71f2 in the fitted section 71f of the toner cartridge 71.

Thus, the toner cartridge 71 which is completely attached to the cartridge attaching section 65 is firmly fixed to the cartridge attaching section 65 in such a manner that the toner cartridge 71 can communicate with the image forming apparatus 1.

Since the fitting protrusion 65e is fitted to the fitting holding section 71f2 by being guided by the fitting guiding section 71f1, the fitting protrusion 65e can be smoothly fitted to the fitting holding section 71f2. When the fitting protrusion 65e moves from the fitting guiding section 71f1 to the fitting holding section 71f2, the fitting protrusion 65e passes through the part having the narrower space between the fit guiding 71f1 and the fitting holding section 71f2.

Therefore, an operator can easily confirm, by feeling with his/her hand or finger, that the toner cartridge 71 is completely attached to the toner attaching section 65, from a change in force necessary to push the toner cartridge 71, namely, such a change from weak force (at the fitting guiding section 71f1) to strong force (at the part having the narrower space between the fitting guiding section 71f1 and the fitting holding section 71f2) and then to weak force (at the fitting holding section 71f2).

Furthermore, since the fitted section 71f includes the fitting guiding section 71f1 which works first and the fitting holding section 71f2 which works after the fitting guiding section 71f1, it is easy to visually check a process in which the fitting protrusion 65e is fitted to the fitting holding section 71f2. That is, an operator who handles the toner cartridge 71 first visually checks a state in which the fitting protrusion 65e is fitted to the fitting guiding section 71f1. With this, the operator can confirm that the toner cartridge 71 is on the way to be completely fitted to the cartridge attaching section 65. Then, the operator visually checks a state in which the fitting protrusion 65e is fitted to the fitting holding section 71f2. With this, the operator can confirm that the toner cartridge 71 has been completely attached firmly to the cartridge attaching section 65.

In the state where the toner cartridge 71 is completely attached to the cartridge attaching section 65, the IC chip 75 held by the memory holding recess 71e1 is fitted to the IC chip fitting section 65c. Thus, by a single action of pushing the toner cartridge 71 into the cartridge attaching section 65, it is possible to simultaneously carry out (i) attachment of the IC chip 75 to the IC chip fitting section 65c and (ii) fitting of the IC chip 75 to the IC chip fitting section 65c.

In the state in which the IC chip 75 is fitted to the IC chip fitting section 65c, as shown in FIG. 12, the IC chip 75 is completely covered with the IC chip fitting section 65c and the memory cover member 71e (see FIG. 6). Therefore, it is possible to prevent toner and dust floating in the image forming apparatus 1 from entering the IC chip fitting section 65c and the memory holding recess 71e1 (see FIG. 6), so as to avoid poor connection of the IC chip 75.

(Detachment of Toner Cartridge from Cartridge Attachment Section)

In order to replace the toner cartridge 71 with a new one, the front door 23 is opened and the toner cartridge 71 is detached from the cartridge attaching section 65. In this case, the above-described operation for attaching the toner cartridge 71 to the cartridge attaching section 65 is carried out reversely.

Specifically, an operator horizontally pulls the toner cartridge 71 toward the front surface of the image forming apparatus 1 by holding the toner cartridge 71 with his/her thumb inserted into the recess 71j of the toner cartridge 71 and other fingers placed on the upper surface of the toner cartridge 71 (see (b) of FIG. 9). This makes it possible to detach the toner cartridge 71 from the cartridge attaching section 65. At the same time, this also makes it possible to detach the IC chip 75 held by the memory holding recess 71e1 from the IC chip fitting section 65c.

During the detachment of the toner cartridge 71, the toner cartridge 71 can be stably moved by being guided by the lower cartridge guiding section 65d and the side cartridge guiding sections 65g of the cartridge attaching section 65.

Further, during the detachment of the toner cartridge 71, the movement of the toner cartridge 71 toward the front surface of the image forming apparatus 1 causes the tension spring 71h to pull and move the shutter 71c, so that the toner supply opening 71b is closed by the shutter 71c (see (a) of FIG. 8). This prevents toner leakage from the toner supply opening 71b.

### SUMMARY

An image forming apparatus 1 of aspect 1 of the present invention includes: a front housing section (front door 23); a front frame (78) provided inside the image forming apparatus 1 so as to be close to a front surface of the image forming apparatus 1;

a front inside cover (79) provided between the front housing section and the front frame (78); and a cartridge attaching section (65), provided between the front housing section and the front frame (78) or the front inside cover (79), to which a toner cartridge (71) including a non-volatile memory (IC chip 75) is detachably attachable, the toner cartridge (71) including a shutter (71c) for opening or closing a toner supply opening (71b) of the toner cartridge (71), the cartridge attaching section (65) including: a shutter opening section (shutter stopping section 65i) which engages with the shutter (71c) as a result of movement of the toner cartridge (71) toward the cartridge attaching section (65), so as to open the shutter (71c); and a non-volatile memory attaching section (IC chip fitting section 65c) to which the non-volatile memory is attached when the toner cartridge (71) is attached to the cartridge attaching section (65).

According to the above configuration, when the toner cartridge 71 is attached to the cartridge attaching section 65, the shutter 71c of the toner cartridge 71 engages with the shutter opening section of the cartridge attaching section 65 as a result of movement of the toner cartridge 71 toward the cartridge attaching section 65, so that the shutter 71c is opened. Further, the non-volatile memory of the toner cartridge 71 is attached to the non-volatile memory attaching section of the cartridge attaching section 65.

Thus, by attachment of the toner cartridge 71 to the cartridge attaching section 65, it is possible to simultaneously carry out (i) opening of the shutter 71c of the toner cartridge 71 and (ii) attachment of the non-volatile memory to the non-volatile memory attaching section, thereby improving operability. Therefore, it is possible (i) to easily attach a toner cartridge to the image forming apparatus and (ii) to, with a simple configuration, attach a non-volatile memory in the toner cartridge to the image forming apparatus in such a manner that the non-volatile memory can communicate with the image forming apparatus, as a result of the attachment of the toner cartridge to the image forming apparatus.

An image forming apparatus 1 of aspect 2 of the present invention may be configured such that, in aspect 1 above, the toner cartridge 71 is attached to the cartridge attaching section 65 as a result of movement of the toner cartridge 71 from the front surface to a back surface of the image forming apparatus 1.

According to the above configuration, by a simple operation of moving the toner cartridge 71 from the front surface to the back surface of the image forming apparatus 1, it is possible (i) to attach the toner cartridge 71 to the cartridge attaching section 65 and (ii) to open the shutter 71c of the toner cartridge 71 and attach the non-volatile memory to the non-volatile memory attaching section, as a result of the attachment.

An image forming apparatus 1 of aspect 3 of the present invention may be configured such that, in aspect 1 or 2 above, the toner cartridge 71 is detached from the cartridge attaching section 65 as a result of movement of the toner cartridge 71 from a back surface to the front surface of the image forming apparatus 1.

According to the above configuration, by a simple operation of moving the toner cartridge 71 from the back surface to the front surface of the image forming apparatus 1, it is possible (i) to detach the toner cartridge 71 from the cartridge attaching section 65 and (ii) to close the shutter 71c of the toner cartridge 71 and detach the non-volatile memory from the non-volatile memory attaching section, as a result of the detachment.

An image forming apparatus 1 of aspect 4 of the present invention may be configured to further include, in any one of aspects 1 to 3 above, a display device (operation panel 21) on an upper surface the image forming apparatus 1, the display device being located partly immediately above a region where the toner cartridge 74 exists and including a front end surface 21a which is located so as to be closer to a back surface of the image forming apparatus 1 than a front surface (outer surface) of the front housing section (front door 23) is.

According to the above configuration, since the display device is located partly immediately above the region where the toner cartridge 74 exists, the display device may have a large size. Even in a case where such a large-size display device is provided in the image forming apparatus, the above configuration makes it possible to easily carry out (i) attachment of the toner cartridge 71 to the cartridge attaching device 65 and (ii), as a result of the attachment, opening of the shutter 71c of the toner cartridge 71 and attachment of the non-volatile memory to the non-volatile memory attaching section.

An image forming apparatus of aspect 5 of the present invention may be configured such that, in aspect 4 above, the front surface 21a of the display device (operation panel 21) is parallel to the front surface (outer surface) of the front housing section (front door 23).

The above configuration makes it possible to provide a large-size display device in the image forming apparatus while (i) preventing the display device from protruding from the front casing of the image forming device 1 and (ii) minimizing an area occupied by the image forming device 1.

An image forming apparatus 1 of aspect 6 of the present invention may be configured to include, in any one of aspects 1 to 5 above, a plurality of toner cartridges aligned in a lateral direction of the image forming apparatus 1, and a waste toner box 69 provided under the plurality of toner cartridges, the waste toner box 69 storing toner supplied to the plurality of toner cartridges and thereafter collected from the plurality of toner cartridges as waste toner.

According to the above configuration, even though the image forming apparatus 1 include the plurality of toner cartridges, the toner supplied to the plurality of toner cartridges and thereafter collected therefrom as the waste toner is stored in the single waste toner box 69. Thus, by providing the single waste toner box 69 which is small and has a large capacity in the image forming apparatus 1, it is possible to simplify the configuration of the image forming apparatus 1 in comparison to a configuration including a plurality of waste toner boxes respectively provided for the plurality of the toner cartridges.

An image forming apparatus 1 of aspect 7 of the present invention may be configured such that, in any one of aspects 1 to 6 above, the cartridge attaching section 65 includes a guiding section for guiding movement of the toner cartridge 71.

According to the above configuration, since the cartridge attaching section 65 includes the guiding section for guiding movement of the toner cartridge 71, it is possible to smoothly and easily move the toner cartridge 71 when attaching the toner cartridge 71 to the cartridge attaching section 65.

An image forming section 1 of aspect 8 of the present invention may be configured such that, in any one of aspects 1 to 7, the toner cartridge 71 has a surface facing the front housing section (front door 23) and having a recess, and the toner cartridge 71 is attached to or detached from the cartridge attaching section 65 with operator's fingers placed on the recess and an upper surface of the toner cartridge 71.

According to the above configuration, even if the plurality of toner cartridges are aligned in a row without any space between them, it is possible to appropriately attach/detach the toner cartridge to/from the cartridge attaching section 65. This makes it possible to configure the image forming apparatus 1 to be further minimized in a width direction.

The present invention is not limited to the description of embodiments above, but may be altered by a skilled person within the scope of the claims. An embodiment based on a proper combination of technical means disclosed in different embodiments is encompassed in the technical scope of the present invention.

### REFERENCE SIGNS LIST

1 Image forming apparatus
12 Automatic document feeder
13 Paper feeding cassette
14 Transfer section
15 Fixing section
16 Paper output tray
21 Operation panel (Display device)
21a Front end surface
23 Front Door (Front housing section)
31 to 34 First to fourth image forming section
35 Intermediate transfer belt unit
36 Transfer belt cleaning device
36a Waste toner conveying pipe
41a to 41d Photoreceptor drum
43a to 43d Developing device
43a1 to 43d1 Toner intake section
43a2 to 43d2 Toner intake opening
45a to 45d Photo conductor cleaning device
45a1 to 45d1 Waste toner conveying pipe
65 to 68 Cartridge attaching section
65a Cartridge facing section
65c IC chip fitting section (Non-volatile memory attaching section)
65d Lower cartridge guiding section
65e Fitting protrusion
65g Cartridge guiding section
65h Cartridge contacting section
65i Shutter stopping section (Shutter opening section)
69 Waste toner box
71 to 74 Toner cartridge
71a Toner storing section
71b Toner supply opening
71c Shutter
71c1 Toner passing opening
71h Tension spring
71e Memory covering member
75 IC chip
77 Fixing drive motor
78 Front frame
79 Front inside cover

1. An image forming apparatus, comprising:
a front housing section;
a front frame provided inside the image forming apparatus so as to be close to a front surface of the image forming apparatus;
a front inside cover provided between the front housing section and the front frame; and
a cartridge attaching section, provided between the front housing section and the front frame or the front inside cover, to which a toner cartridge including a non-volatile memory is detachably attachable,
the toner cartridge including a shutter for opening or closing a toner supply opening of the toner cartridge,
the cartridge attaching section including:
a shutter opening section which engages with the shutter as a result of movement of the toner cartridge toward the cartridge attaching section, so as to open the shutter; and
a non-volatile memory attaching section to which the non-volatile memory is attached when the toner cartridge is attached to the cartridge attaching section.

2. The image forming apparatus as set forth in claim 1, wherein the toner cartridge is attached to the cartridge attaching section as a result of movement of the toner cartridge from the front surface to a back surface of the image forming apparatus.

3. The image forming apparatus as set forth in claim 1, wherein the toner cartridge is detached from the cartridge attaching section as a result of movement of the toner cartridge from a back surface to the front surface of the image forming apparatus.

4. The image forming apparatus as set forth in claim 1, further comprising a display device on an upper surface of the image forming apparatus,
the display device being located partly immediately above a region where the toner cartridge exists,
the display device including a front end surface which is located so as to be closer to a back surface of the image forming apparatus than a front surface of the front housing section is.

5. The image forming apparatus as set forth in claim 1, wherein the front end surface of the display device is parallel to the front surface of the front housing section.
